(19) United States
(12) Patent Application Publication
(10) Pub. No.: US 2013/0170041 A1
(43) Pub. Date: Jul. 4, 2013

(54) DIFFRACTIVE OPTICAL ELEMENT AND METHOD FOR PRODUCING DIFFRACTIVE OPTICAL ELEMENT

(71) Applicants: Yuka Okada, Hyogo (JP); Tatsutoshi Suenaga, Osaka (JP); Akiko Murata, Osaka (JP)

(72) Inventors: Yuka Okada, Hyogo (JP); Tatsutoshi Suenaga, Osaka (JP); Akiko Murata, Osaka (JP)

(73) Assignee: PANASONIC CORPORATION, Osaka (JP)

(21) Appl. No.: 13/820,842

(22) PCT Filed: Jul. 11, 2012
(86) PCT No.: PCT/JP2012/004474

§ 371 Date: Mar. 5, 2013

(30) Foreign Application Priority Data
Aug. 24, 2011 (JP) 2011-182872

(51) Int. Cl. G02B 5/18

(52) U.S. Cl. CPC G02B 5/18
USPC 359/566; 427/163.1; 427/532

(57) ABSTRACT

A diffractive optical element disclosed in the present application includes a body 102 formed of a first optical material containing a first resin, the body 102 having a surface 102a including a first area 105 at which a diffraction grating 104 is provided and a second area 106 located outer to the first area; an optical adjustment layer 103 formed of a second optical material containing a second resin, the optical adjustment layer 103 being provided on the body while covering the first area and at least a part of the second area 106 of the surface of the body; and an adhesive interface section 109 containing an adhesive material which is adhesive to the second optical material, the adhesive interface section 109 being, at the second area 106 of the surface of the body, at least partially located below the optical adjustment layer 103 and being located at least in a region from the surface to the inside of the body.

### TECHNICAL FIELD

The present application relates to a diffractive optical element, specifically to a diffractive optical element including two or more components respectively containing different resins from each other and a method for producing the same.

### BACKGROUND ART

A diffractive optical element (diffraction grating lens) has a structure which includes a body formed of an optical material such as glass, a resin or the like, and a diffraction grating, provided on the body, for diffracting light. The diffractive optical element is used in an optical system of various types of optical devices such as image pickup devices, optical storage devices and the like. Known diffractive optical elements include, for example, a lens designed to collect diffracted light of a specific order to one point, a spatial low-pass filter, a polarizing hologram and the like.

The diffractive optical element has a feature of allowing the optical system to be compact. In addition, light having a longer wavelength is diffracted more largely, as opposed to the case of refraction. Therefore, a combination of a diffractive optical element and a usual refractive optical element utilizing refracted light can improve chromatic aberration or field curvature of an optical system.

However, the diffractive optical element has the following problem. Diffraction efficiency theoretically depends on the wavelength of light. Therefore, a diffractive optical element designed to optimize the diffraction efficiency for light having a specific wavelength has a lower diffraction efficiency for light of other wavelengths. For example, when a diffractive optical element is used in an optical system which utilizes white light, such as a lens for a camera or the like, the wavelength dependence diffraction efficiency causes color nonuniformity or flair due to light of unnecessary orders. This makes it difficult to construct an optical system having appropriate optical characteristics only with a diffractive optical element.

In order to solve this problem, Patent Document 1 discloses a method for decreasing the wavelength dependence of diffraction efficiency. According to Patent Document 1, a diffraction grating is provided at a surface of a body formed of an optical material and is covered with an optical adjustment layer formed of an optical material different from that of the body, so that a phase-type diffractive optical element is formed. The two optical materials are selected such that the optical characteristics of the diffractive optical element fulfill a prescribed condition. In this manner, the diffraction efficiency for the designed diffraction order is increased regardless of the wavelength; namely, the wavelength dependence of diffraction efficiency is decreased.

Where the wavelength of light transmitted through the diffractive optical element is λ, the refractive indexes of the two types of optical materials for light of the wavelength λ are n1(λ) and n2(λ), and the depth of the diffraction grating is d, the diffraction efficiency for light having the wavelength λ is 100% when the following expression (1) is fulfilled.

$$d = \frac{λ}{\vert n 1 ( λ ) - n 2 ( λ ) \vert} \qquad ( 1 )$$

Therefore, the wavelength dependence of diffraction efficiency can be decreased by combining an optical material having the refractive index n1(λ) and an optical material having the refractive index n2(λ) which provide such a wavelength dependence that d is generally constant in the wavelength range of the light to be used. In general, a material having a high refractive index and a low wavelength dispersion and a material having a low refractive index and a high wavelength dispersion are combined. Patent Document 1 discloses using glass or a resin as a first optical material for the body and using an ultraviolet-curable resin as a second optical material.

Patent Document 2 discloses, for producing a phase-type diffractive optical element having substantially the same structure, using glass as the first optical element and using an energy-curable resin having a viscosity of 5000 mPa·s or less as the second optical material. According to Patent Document 2, use of these materials can decrease the wavelength dependence of diffraction efficiency and effectively prevent color nonuniformity, generation of flair due to light of unnecessary orders, and the like.

In the case where glass is used as the first optical material for the body, there are the following problems. As compared with a resin, glass is difficult to be precisely processed. Therefore, it is not easy to narrow the pitch of the diffraction grating and thus to improve the diffraction performance. For this reason, it is difficult to improve the optical performance while decreasing the size of the optical element. In addition, the molding temperature of glass is higher than that of a resin. Therefore, the durability of a die used for molding glass is lower than that of a die used for molding a resin. This causes a problem in productivity.

By contrast, in the case where a resin is used as the first optical material for the body, the diffraction grating is formed with superior processability and moldability to the case where glass is used. However, with a resin, it is more difficult to realize various values of refractive index than with glass. This decreases the difference between the refractive index of the first optical material and the refractive index of the second optical material. In this case, as is clear from expression (1), the depth d of the diffraction grating is increased.

Therefore, although the body is formed with high processability, the die used for forming the diffraction grating needs to have deeper grooves, and the grooves need to have pointed tips. Production of such a die requires a difficult work of processing. In addition, as the diffraction grating is deeper, the pitch of the diffraction grating needs to be larger due to the processing work constraints regarding the production of at least one of the body and the die. This makes it impossible to increase the number of the grooves of the diffraction grating, which adds more constrains to the design of the diffractive optical element.

In order to solve these problems, the Applicant of the present application proposes, in Patent Document 3, using a composite material containing inorganic particles having an average particle diameter of 1 nm to 100 nm in a matrix resin for the optical adjustment layer. Use of this composite material makes the refractive index and the Abbe number controllable by adjusting the type of material, or the amount of, the inorganic particles to be dispersed. Therefore, a refractive index and an Abbe number which cannot be realized by the conventional resin can be provided. Owing to this, in the case where a resin is used as the first optical material for the body, use of the composite material for the optical adjustment layer can increase the freedom of design of the diffraction grating, improve the moldability, and provide high wavelength characteristics of the diffraction grating.

### CITATION LIST

### Patent Literature

Patent Document 1: Japanese Laid-Open Patent Publication No. 10-268116
Patent Document 2: Japanese Laid-Open Patent Publication No. 2001-249208
Patent Document 3: International Publication 07/026,597

### SUMMARY OF INVENTION

### Technical Problem

However, studies made by the inventors of the present application have found that a conventional diffractive optical element in which the body and the optical adjustment layer are formed of resin materials may not have a sufficient adhesiveness between the body and the optical adjustment layer. Non-limiting, illustrative embodiments of the present application provide a diffractive optical element having an improved adhesiveness between the body and the optical adjustment layer, and a method for producing the same.

### Solution to Problem

A diffractive optical element according to one embodiment of the present invention includes a body formed of a first optical material containing a first resin, the body having a surface including a first area in which a diffraction grating is provided and a second area located outer to the first area; an optical adjustment layer formed of a second optical material containing a second resin, the optical adjustment layer being provided on the body while covering the second area and the first area of the surface; and an adhesive interface section containing an adhesive material which is adhesive to the second optical material, the adhesive interface section being, at the second area of the surface of the body, at least partially located below the optical adjustment layer and being located in a region from the surface of the body to the inside of the optical adjustment layer.

A method for producing a diffractive optical element according to one embodiment of the present invention includes step (A) of preparing a body formed of a first optical material containing a first resin, the body having a surface including a first area in which a diffraction grating is provided and a second area located outer to the first area; step (B) of providing a substance of an adhesive material which is adhesive on at least a part of the second area of the surface of the body; step (C) of providing a substance of a second optical material containing a substance of a second resin on the body so as to cover the entirety of the first area of the surface of the body and at least a part of the substance of the adhesive material provided on the second area; and step (D) of curing the substance of the second resin to form an optical adjustment layer formed of the second optical material.

### Advantageous Effects of Invention

According to one embodiment of the present invention, the adhesive interface section containing an adhesive material which is adhesive to the second optical material is provided at the second area of the body from the surface to the inside of the body. Owing to the adhesive interface section, the adhesiveness between the body and the optical adjustment layer is improved. Thus, an end of the optical adjustment layer can be prevented from floating or being delaminated from the body due to the stress caused by the contraction of the resin or the release of the resin from the die in a step of forming the optical adjustment layer.

### BRIEF DESCRIPTION OF DRAWINGS

FIGS. 1(a) and (b) are respectively a plan view and a cross-sectional view of a diffractive optical element in Embodiment 1, and FIG. 1(c) is a cross-sectional view showing another example of Embodiment 1.

FIGS. 2(a), (b) and (c) are each a plan view showing other positions of adhesive interface sections in the diffractive optical element shown in FIG. 1.

FIG. 3 is a cross-sectional view showing another structure of a body in the diffractive optical element shown in FIG. 1.

FIGS. 4(a) and (b) are each a cross-sectional view showing a diffractive optical element in Embodiment 2.

FIG. 5 is a graph showing an example of the contact time between the first optical material and a substance of the second optical material vs. the thickness of the adhesive interface section to be formed in the diffractive optical element.

FIGS. 6(a) through (e) are cross-sectional views showing steps of a method for producing a diffractive optical element in an embodiment.

FIGS. 7(a) and (b) show examples of positional arrangement of the adhesive interface section and an adhesive material layer.

FIGS. 8(a) and (b) show examples of positional arrangement of ends of an optical adjustment layer, the adhesive interface section and the adhesive material layer.

FIG. 9 is a cross-sectional view showing a conventional diffractive optical element with a deformed diffraction grating.

FIG. 10 is a cross-sectional view showing conventional diffractive optical element having a refractive index-changed layer formed at an interface between the body and the optical adjustment layer.

FIGS. 11(a) and (b) are each a cross-sectional view for explaining unnecessary diffracted light caused in a conventional diffractive optical element in which a refractive index-changed layer is formed.

FIG. 12 is a cross-sectional view for explaining refraction of light in an optical element in which a refractive-index changed layer is formed at an interface between the body and the optical adjustment layer.

### DESCRIPTION OF EMBODIMENTS

Regarding the phase-type diffractive optical elements disclosed in Patent Documents 1 through 3, the inventors of the present application studied problems occurring in the case where the body and the optical adjustment layer are formed of resin-containing materials, especially, an influence exerted on the diffraction efficiency by the stability of the interface between the body and the optical adjustment layer.

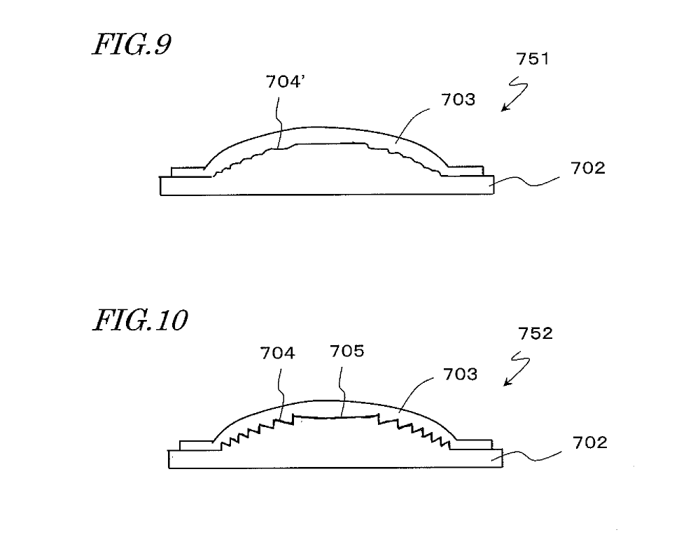

As shown in FIG. 9, a conventional diffractive optical element 751 includes a body 702 having a diffraction grating 704′ at a surface thereof and an optical adjustment layer 703 provided so as to cover the diffraction grating 704′. The optical adjustment layer 703 and the body 702 are respectively formed of resin-containing optical materials. In the case where the interaction between both of the optical materials is strong, the shape of the diffraction grating 704′ is destroyed at an interface at which the body 702 and the optical adjustment layer 703 contact each other as shown in FIG. 9 due to swelling or dissolution of the body 702. When the shape of the diffraction grating 704′ is destroyed, diffracted light of a desired order is not provided with a sufficient strength or unnecessary diffracted light is generated.

The inventors of the present application found that even if the shape of the diffraction grating is not changed, diffracted light of an order different from the order for which for the diffractive optical element is designed may be caused (hereinafter, such diffracted light will be referred to as “unnecessary diffracted light”). As a result of detailed experiments, the inventors of the present application confirmed the following. As shown in FIG. 10, when the resin contained in the optical adjustment layer 703 of a diffractive optical element 752 permeates into the inside of the body 702 from a surface thereof, the refractive index of a part of the body 702 into which the resin has permeated is changed, and a layer 705 having a refractive index different from that of the body 702 (hereinafter, this layer will be referred to as a “refractive index-changed layer”) is formed at an interface between the body 702 and the optical adjustment layer 703. The presence of the refractive index-changed layer 705 can be confirmed by use of an optical microscope, a prism coupler capable of measuring the refractive index with high precision, or the like. The confirmation by the inventor of the present application shows that the thickness of the refractive index-changed layer 705 is about 50 nm to about 5000 nm.

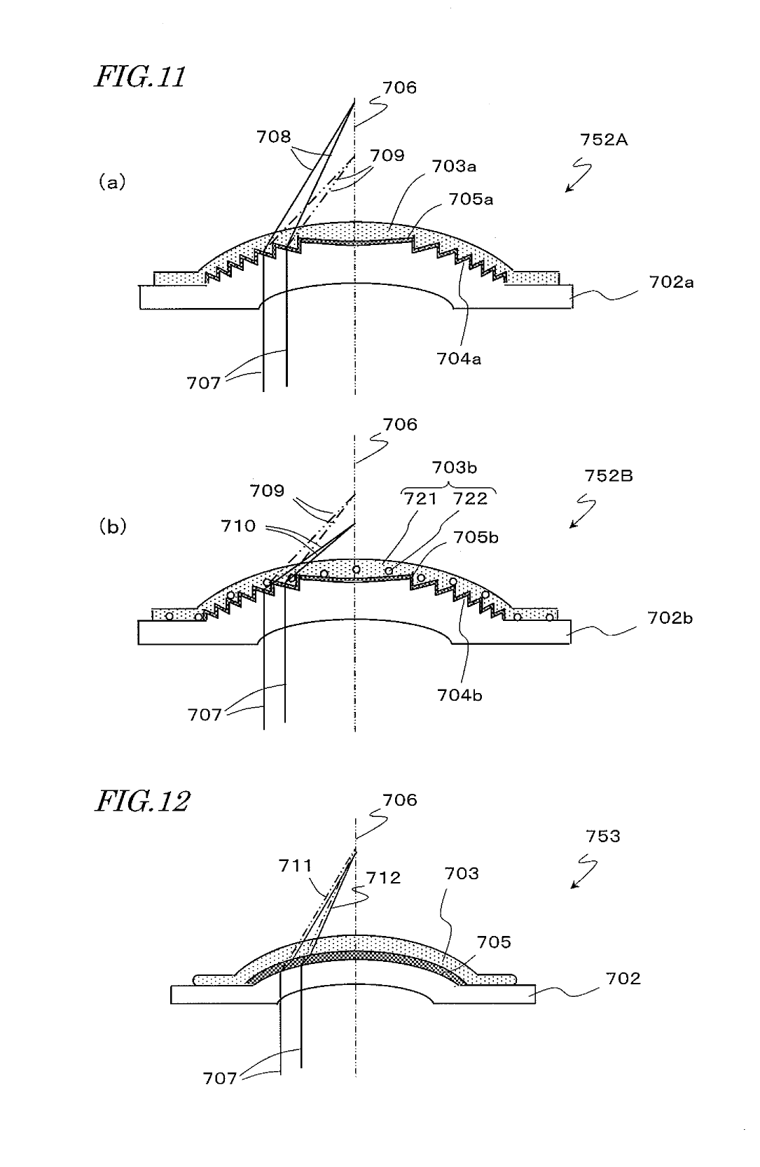

Now, a diffractive optical element 752A shown in FIG. 11(a) will be discussed. The diffractive optical element 752A includes a body 702a formed of a resin having a refractive index N1 and an optical adjustment layer 703a formed of a resin having a refractive index N2. The diffractive optical element 752A utilizes first-order diffracted light. In the case where a refractive index-changed layer 705a is formed for the above-described reason, a refractive index N3 thereof fulfills the relationship of N1<N3<N2. In the case where the refractive indexes N1 and N2 are designed to fulfill expression (1) for the wavelength range of the light to be used, the difference between the optical distances of steps which form the diffraction grating 704a, namely, the phase difference, is made smaller than the designed value by the refractive index-changed layer 705a being formed. Therefore, the diffraction efficiency of the diffractive optical element 752A when light 707 of the wavelength range to be used is incident, namely, the output efficiency of first-order diffracted light 709, is made lower than the designed value. At this point, zeroth-order diffracted light 708, which has a longer focal distance than that of the first-order diffracted light 709, is mainly generated as the unnecessary diffracted light.

Now, a diffractive optical element 752B shown in FIG. 11(b) will be discussed. The diffractive optical element 752B uses, for the optical adjustment layer, a composite material containing a matrix material 721 and inorganic particles 722 as disclosed in Patent Document 3, and utilizes first-order diffracted light. The refractive index of a body 702 is N1, the refractive index of an optical adjustment layer 703b is N2, and the refractive index of the matrix material 721 of the optical adjustment layer 703b is N4. In the case where the refractive indexes fulfill the relationships of N1<N2 and N4<N1, the refractive index N3 of a refractive index-changed layer 705b to be generated fulfills the relationship of N1>N3<N2. A reason for this is that the inorganic particles 722 of the nanometer order cannot move to the body 702b, and only the matrix material 721 having a refractive index smaller than that of the body 702b permeates into the body 702b and generates the refractive index-changed layer 705b.

In this case, the phase difference is made larger than the designed value due to the refractive index-changed layer 705b, and the output efficiency of the first-order diffracted light 709 is made lower than the designed value. At this point, second-order diffracted light 710, which has a shorter focal distance than that of the first-order diffracted light 709, is mainly generated as the unnecessary diffracted light.

Referring to FIG. 12, in the case of a usual optical element 753 utilizing only a usual refraction phenomenon, even if the refractive index-changed layer 705 is generated between the body 702 and the optical adjustment layer 703, the angle of refraction of the incident light 707, entering from the body 702, at the interface between the body 702 and the refractive index-changed layer 705 is small as long as the difference between the refractive index of the body 702 and the refractive index of the refractive index-changed layer 705 is about 0.01. When the refractive index-changed layer 705 is thin, the distance by which the incident light 707 proceeds in the refractive index-changed layer 705 at the angle of refraction is short. Therefore, even if the refractive index-changed layer 705 is generated, the difference between the optical path of designed output light 711 and the optical path of actual output light 712 is small. Thus, the influence of the difference on the optical performance is negligibly small. By contrast, in the case of a diffractive optical element, even if the refractive index-changed layer is too small to be observed by an optical microscope, the condition (1) for diffraction is not fulfilled. Therefore, the generation of the refractive index-changed layer directly leads to the generation of unnecessary diffracted light, and as a result, the diffraction efficiency for the light of the order for which the diffractive optical element is designed is significantly decreased.

Especially in the case where a material containing an ultraviolet-curable resin or a thermosetting resin is used for the optical adjustment layer from the viewpoint of productivity, the resin in an uncured state, namely, a monomer or an oligomer, contacts the body in the step of forming the optical adjustment layer. The monomer and the oligomer each have a molecular weight smaller than that of the cured resin, and therefore have reactivity to, and permeability into, the body higher than those of the cured resin. Namely, the deformation of the diffraction grating 704 and the decrease of the diffraction efficiency caused by the generation of the refractive index-changed layer (705a, 705b) described above are likely to occur.

In the case where a composite material is used for the optical adjustment layer, a solvent may be incorporated into a substance of the optical adjustment layer in order to disperse the inorganic particles 722 in the matrix material 721 or in order to adjust the viscosity of the substance of the optical adjustment layer in the step of forming the optical adjustment layer 703b. Such a solvent is dissolved or permeates into the body 702b to generate the refractive index-changed layer 705b and thus causes the above-described problems, like the resin in an uncured state in the substance of the optical adjustment layer.

As a measure to solve the problems, it is considered to make the difference between the solubility parameter of the resin used to form the body 702 and the solubility parameter of the resin used to form the optical adjustment layer 703 greater than a prescribed value, or to adopt a process by which the time of contact between the resin in an uncured state or the solvent and the body 702 is made as short as possible. However, when such a measure is taken and thus the generation of the refractive index-changed layer 705 is prevented, the interaction between the two types of resins is made small. When this occurs, the resin molecules are not intertwined sufficiently at the interface, which decreases the adhesiveness between the body 702 and the optical adjustment layer 703. As a result, when some stress is applied to the diffractive optical element, the optical adjustment layer 703 floats or is delaminated from the body 702. The stress which may act on the diffractive optical element may be a stress generated during the production process, for example, a stress applied when the resin component used to form the optical adjustment layer 703 is cured and contracted or a stress applied when the optical adjustment layer 703 formed by molding is released from the die; or a stress generated due to an environment of use, for example, a thermal stress generated at the time of temperature change due to the difference in the coefficient of thermal expansion between the body 702 and the optical adjustment layer 703, or a stress caused by cubical expansion which occurs when moisture or chemical is absorbed.

As described above, in the case where the optical adjustment layer 703 having a low adhesiveness is formed only on an effective area of the diffractive optical element, even if the floating or delamination of an end of the optical adjustment layer 703 from the body 702 is small, the geometric structure and the optical structure in the vicinity of the diffraction grating are changed. This generates a light beam which is not assumed at the time of designing such as unnecessary diffracted light, stray light or the like. As a result, the characteristics of the diffractive optical element are made significantly lower than being designed. In the case where the floating or delamination of the optical adjustment layer 703 occurs gradually, the long-term reliability of the diffractive optical element is spoiled.

In light of these problems, the inventors of the present application conceived a diffractive optical element having a novel structure. One embodiment of the present invention is as follows.

A diffractive optical element according to one embodiment of the present invention includes a body formed of a first optical material containing a first resin, the body having a surface including a first area in which a diffraction grating is provided and a second area located outer to the first area; an optical adjustment layer formed of a second optical material containing a second resin, the optical adjustment layer being provided on the body while covering the second area and the first area of the surface; and an adhesive interface section containing an adhesive material which is adhesive to the second optical material, the adhesive interface section being, at the second area of the surface of the body, at least partially located below the optical adjustment layer and being located in a region from the surface of the body to the inside of the body.

The adhesive interface section continuously surrounds the first area at the second area of the surface of the body.

A plurality of the adhesive interface sections are provided; and the plurality of adhesive interface sections are located at the second area of the surface, at an interval around the first area.

The body has a curved base-shaped part having a lens function in the first area of the surface, and the diffraction grating includes a plurality of rings located concentrically on the base-shaped part.

The second area surrounds the first area at the surface, and the adhesive interface section is located in a concentric manner with the concentric rings at the second area, as centered around a point matching the center of the concentric rings of the diffraction grating.

The adhesive material contains the second resin.

The second resin is an energy-curable resin.

The adhesive material contains a third resin.

The third resin is an energy-curable resin.

The third resin is a radiation curable resin having a functional group copolymerizable with the second resin.

A solubility parameter of the third resin and a solubility parameter of the first resin has a difference of 0.8 [cal/cm³]^{1/2} or less.

The first resin is a thermoplastic resin.

The adhesive interface section includes, in the second area, a part located in a region from the surface of the body to the inside of the optical adjustment layer.

The diffractive optical element further includes an adhesive material layer located between the adhesive interface section and the optical adjustment layer and containing the adhesive material.

The body has a concaved and convexed-shaped part located at the second area of the surface, and the adhesive interface section is located in a region from a surface of the concaved and convexed-shaped part to the inside of the body.

The surface of the body includes a third area which is located outer to the second area and is flat.

The second optical material contains inorganic particles, which are dispersed in the second resin.

The optical adjustment layer is in direct contact with the surface of the body in the entirety of the first area.

A method for producing a diffractive optical element according to one embodiment of the present invention includes the steps of: (A) preparing a body formed of a first optical material containing a first resin, the body having a surface including a first area in which a diffraction grating is provided and a second area located outer to the first area; (B) providing a substance of an adhesive material which is adhesive on at least a part of the second area of the surface of the body; (C) providing a substance of a second optical material containing a substance of a second resin on the body so as to cover the entirety of the first area of the surface of the body and at least a part of the substance of the adhesive material provided on the second area; and (D) curing the substance of the second resin to form an optical adjustment layer formed of the second optical material.

In the step (D), the substance of the adhesive material is cured at the same time as the substance of the second resin.

In the step (D), the substance of the second resin and the substance of the adhesive material are cured by radiation of an energy beam.

The step (C) includes the steps of providing the substance of the second optical material on a die; and providing, on the die, the body having the substance of the adhesive material provided in the second area.

The method further includes step (E) of heating the body after step (C).

The substance of the adhesive material contains a solvent, and in the step (E), the solvent is removed from the substance of the adhesive material.

The body has a concaved and convexed-shaped part at the second area of the surface, and in the step (A), the body is formed by molding by which the concaved and convexed-shaped part at the second area is formed by use of a die having a shape corresponding to the concaved and convexed-shaped part at a surface thereof.

### Embodiment 1

Hereinafter, a diffractive optical element according to Embodiment 1 of the present invention will be described.

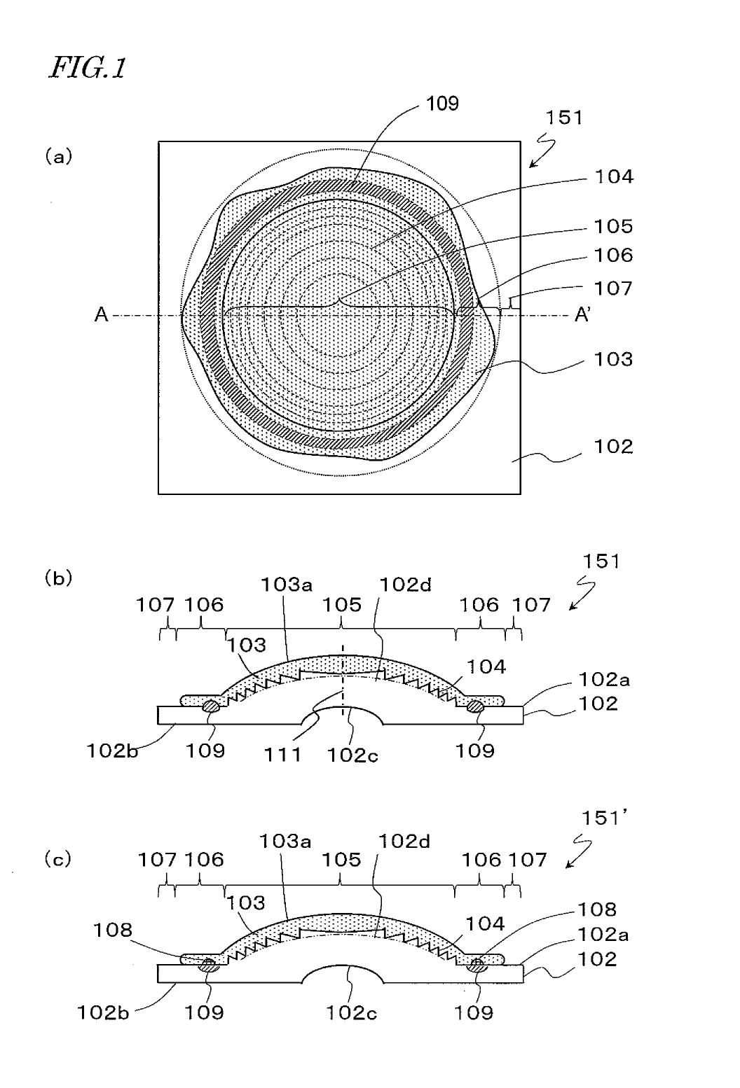

FIG. 1 shows a structure of a diffractive optical element 151 in Embodiment 1. FIG. 1(a) is a plan view thereof, and FIG. 1(b) is a cross-sectional view of FIG. 1(a) taken along line A-A′. As shown in FIG. 1(b), the diffractive optical element 151 includes a body 102, an optical adjustment layer 103, and an adhesive interface section 109.

1. Body 102

The body 102 is formed of a first optical material containing a first resin, and has a surface 102a. As shown in FIGS. 1(a) and (b), the surface 102a of the body 102 includes a first area 105 and a second area 106. The first area 105 has a diffraction grating 104.

In this embodiment, the surface 102a of the body 102 has a curved base-shaped part 102d having a lens function in the first area 105, and the curved base-shaped part 102d has the diffraction grating 104. The diffraction grating 104 has a plurality of rings located concentrically. The diffraction grating 104 has a cross-section in a radial direction which may be rectangular, sawtooth-shaped, step-shaped, curved, fractal-shaped, random-shaped or the like, or of any other shape. The rings of the diffraction grating 104 may be arranged in any pattern or at any pitch which fulfills the characteristics required of the diffractive optical element 151.

In the case where the step depth d of the rings of the diffraction grating 104 fulfills the relationship of expression (1) above, the diffractive optical element 151 can provide a diffraction efficiency of 100% regardless of the wavelength. In expression (1), n1(λ) is the refractive index of the first optical material used to form the body 102 for light of the wavelength λ, and n2(λ) is the refractive index of the second optical material used to form the light adjusting layer 103 for light of the wavelength λ. In actuality, however, it is not necessary that the diffraction efficiency is 100%, and the diffractive optical element 151 can actually provide a sufficient optical performance as long as the diffraction efficiency is about 90% or higher. According to detailed studies, this condition is represented by expression (1′).

$$0.9 d \leq \frac{λ}{\vert n 1 ( λ ) - n 2 ( λ ) \vert} \leq 1.1 d \qquad ( {1}^{′} )$$

The base-shaped part 102d has an envelope surface passing a bottom part of the diffraction grating 104 (bottom part of step of each ring) or a top part thereof (top part of step of each ring). The base-shaped part 102d may have a spherical, aspherical, or cylindrical surface. Especially in the case where the base-shaped part 102d has an aspherical surface, lens aberration, which cannot be corrected in the case where the base-shaped part 102d has a spherical surface, can be corrected. In this embodiment, as shown in FIG. 1, the base-shaped part 102d is convexed. Alternatively, the base-shaped part 102d may be concaved or planar in accordance with the functions required of the diffractive optical element 151 in the optical system.

In this embodiment, a surface 102b of the body 102 opposite to the surface 102a is flat, and has a curved part 102c centered around a point matching the center of the concentric rings of the diffraction grating 104. The curved part 102c has a function of defining the optical path by refraction, and the shape thereof is determined in accordance with the design of the entire optical system including the diffractive optical element 151. In this embodiment, as shown in FIG. 1, the curved part 102c is concaved. Alternatively, the curved part 102c may be convexed in accordance with the functions required of the diffractive optical element 151 in the optical system. Still alternatively, the surface 102b may be planar without the curved part 102c.

In this embodiment, the body 102 has the diffraction grating 104 and the optical adjustment layer 103 only at one surface 102a thereof. Alternatively, the body 102 may have the diffraction grating 104 and the optical adjustment layer 103 at both of the surfaces 102a and 102b. In the case where the diffraction grating 104 is provided at both of the surfaces, the depth of the grooves and the cross-sectional shape of the diffraction grating 104 at one surface may be the same as, or different from, those of the diffraction grating 104 at the other surface. The material and the thickness of the optical adjustment layer 103 on one surface may be the same as, or different from, those of the optical adjustment layer 103 on the other surface.

At the surface 102a of the body 102, the second area 106 is located outer to the first area 105. The second area 106 may completely surround the first area 105. As described below, the adhesive interface section 109 is provided in the second area 106. In this embodiment, the surface 102a of the body 102 is flat in the second area 106.

The surface 102a of the body 102 may further include a third area 107 outer to the second area 106. In this case, it is preferable that the third area 107 is flat. The third area 107 thus provided can be used as a holding section for mounting the diffractive optical element 151 on an optical module. Alternatively, the third area 107 may be used as a reference plane for providing a high mounting precision between components of the optical module or for adjusting the focus position.

In the case where the third area 107 is used as the reference plane for mounting the diffractive optical element 151 on the optical module, it is preferable that the third area 107 has a surface roughness Ra of 1.6 μm or less. The shape and the size of the third area 107 are appropriately determined in accordance with the specifications or the like required by the optical module or device into which the diffractive optical element 151 is to be incorporated, and are not specifically limited in this embodiment.

As described above, the body 102 is formed of the first optical material containing the first resin. A reason for using a resin-containing material as the first optical material is that when such a material is used, lenses can be produced by a highly mass-productive method such as injection molding or the like. In addition, a resin-containing material is easily precision-processed by molding or any other processing method. This makes it possible to reduce the pitch of the diffraction grating 104. Thus, the performance of the diffractive optical element 151 can be improved, and the size and the weight of the diffractive optical element 151 can be reduced.

It is preferable to select, as the first resin, a resin which fulfills the following conditions among light transmitting resin materials generally used as materials of an optical device.

(i) Has a refractive index characteristic and a wavelength dispersion characteristic which can decrease the wavelength dependence of diffraction efficiency of the diffractive optical element 151 for light of the order for which the diffractive optical element 151 is designed.

(ii) Maintains the light-transmittance and the refractive index characteristic without being eroded by a substance of a second resin (monomer or oligomer) contained in the substance of the optical adjustment layer 103, and keeps the shape of the diffraction grating 104.

(iii) Forms the adhesive interface section 109 by permeation or dissolution of a third resin into an adhesive material.

The first resin may be appropriately selected from, for example, polycarbonate resins (e.g., “Panlite” produced by Teijin Chemicals Ltd.; “Lexan” and “Xylex” produced by SABIC Innovative Plastics Holding BV; etc.), acrylic resins such as polymethyl methacrylate (PMMA), alicyclic acrylic resins and the like, alicyclic olefin resins (e.g., “ZEONEX” produced by Zeon Corporation; “Apel” produced by Mitsui Chemical Inc.; etc.), polyester-based resins (e.g., “OKP4” produced by Osaka Gas Chemicals Co., Ltd.; etc.), silicone resins, and the like.

Resins usable as the first resin also include copolymeric resins, polymer alloys, and polymer blends obtained as a result of incorporating any other resin into any of the above-mentioned resins for the purpose of improving the moldability, mechanical characteristics or the like. In addition, any of the following components can be incorporated into any of the above-mentioned resins when necessary:

inorganic particles for adjusting optical characteristics such as refractive index and the like or dynamic characteristics such as thermal expandability and the like; and additives such as dyes, pigments and the like for absorbing electromagnetic waves of a particular wavelength range.

2. Optical Adjustment Layer 103

As described above, the optical adjustment layer 103 is provided to decrease the wavelength dependence of diffraction efficiency of the diffractive optical element 151. In the case where the optical adjustment layer 103 is formed on the body 102 having the diffraction grating 104 on at one of the surfaces thereof to construct a phase-type diffraction grating, the depth d of the diffraction grating at which the diffraction efficiency of the lens for the first-order light having a certain wavelength λ is 100% is given by expression (1). Where the right term of expression (1) has a constant value for a certain wavelength range, the diffraction efficiency for the first-order light does not have the wavelength dependence in this wavelength range. In order to realize this, the first optical material used to form the body 102 and the second optical material used to form the optical adjustment layer 103 may be a combination of a material having a low refractive index and a high wavelength dispersion and a material having a high refractive index and a low wavelength dispersion.

As described above, when a combination of the first optical material and the second optical material which fulfills expression (1′) for the entire wavelength range of visible light of 400 nm to 700 nm is used, the diffraction efficiency for the first-order light is about 90% or higher for the wavelength range of visible light. Thus, the diffractive optical element 151 does not substantially depend on the wavelength. When such a diffractive optical element 151 is adopted as, for example, a lens for image pickup, generation of flair or the like is suppressed and thus the image quality is improved.

The optical adjustment layer 103 provides no problem in terms of the optical characteristics as long as having a smooth surface with the convexes and concaves of the diffraction grating 104 being buried completely. When the thickness of the optical adjustment layer 103 is excessively large, the following problems occur. When the diffractive optical element 151 is used as a lens, the comatic aberration and the like are increased. In addition, during the formation of the optical adjustment layer 103, the influence of the curing and contraction of the resin is increased, which may possibly make it difficult to control the shape of the surface of the optical adjustment layer 103 and thus decrease the light collection characteristic. From the above-described viewpoints, the thickness of a thickest part of the optical adjustment layer 103 is preferably equal to or greater than the depth d of the diffraction grating and 200 μm or less, and is more preferably equal to or greater than the depth d of the diffraction grating and 100 μm or less.

A nanocomposite material may be used as the material of the optical adjustment layer 103. In this case, as compared with the case where a single type of resin is used, the difference between the refractive index of the body 102 and the refractive index of the optical adjustment layer 103 can be made larger. Therefore, as is clear from expression (1), the depth d of the diffraction grating can be made smaller. This decreases the required thickness of the optical adjustment layer 103 and also improves the light transmittance.

A surface 103a of the optical adjustment layer 103 which is opposite to the body 102 may be formed to have substantially the same shape as that of the base-shaped part 102d (envelope surface) passing the bottom part of the diffraction grating 104. With such an arrangement, the chromatic aberration, field curvature and the like are improved with good balance by a combination of the refraction action and the diffraction action. As a result, a lens having a high image pickup performance with an improved MTF characteristic can be provided.

The optical adjustment layer 103 is formed so as to cover the first area 105 of the surface 102a of the body 102 and also at least a part of the second area 106. This is for the purpose of suppressing the deterioration of the optical characteristics due to the floating or delamination of the optical adjustment layer 103 from the body 102. More preferably, the optical adjustment layer 103 is formed so as to cover at least a part of the adhesive interface section 109.

The optical adjustment layer 103 is formed of the second optical material containing the second resin. The second optical material is selected from materials having a refractive index characteristic which can fulfill expression (1′) as described above, in consideration of characteristics such as the non-erosiveness into the first area 105 of the surface 102a of the body 102, shape controllability, ease of handling in the production process, environment resistance and the like. Preferably, the second optical material is unlikely to erode the first optical material and is unlikely to form a refractive index-changed layer described above. Specifically, the difference between the solubility parameter (SP value) of the first resin contained in the first optical material used to form the body 102 and the solubility parameter of the second resin is preferably 0.4 [cal/cm³]^{1/2} or greater, and is more preferably 0.8 [cal/cm³]^{1/2} or greater.

The solubility parameter is a square root of the cohesive energy density in the regular solution theory. The solubility parameter δ of a chemical substance is defined by the following expression by use of the molar volume V and the cohesive energy per mole ΔE.

δ=(ΔE/V)½

The solubility parameter is an index of an intermolecular force of a chemical substance. As the solubility parameters of two chemical substances are close to each other, the affinity between the two chemical substances is higher. The solubility parameter can be derived by various methods, for example, a method of calculating from the molecular structural formula by Fedors et al. The solubility parameters used in this specification are values found by such a molecular structural formula.

As long as the second resin and the first resin fulfill the above-mentioned relationship of the solubility parameters, there is no specific limitation on the resin used as the second resin. Resins usable as the second resin include, for example, (meth)acrylic resins such as poly(methyl methacrylate), acrylate, methacrylate, urethane acrylate, epoxy acrylate, polyester acrylate and the like; epoxy resins; oxetane resins; ene-thiol resins; polyester resins such as polyethylene terephthalate, polybutylene terephthalate, polycaprolactone and the like; polystyrene resins such as polystyrene and the like; olefin resins such as polypropylene and the like; polyamide resins such as nylon and the like; polyimide resins such as polyimide, polyetherimide and the like; poly(vinyl alcohol); butyral resins; vinyl acetate resins; alicyclic polyolefin resins; and the like. Mixtures and copolymers thereof are usable, and resins obtained by modifying these resins are usable.

Especially among these resins, energy-curable resins such as thermosetting resins, radiation curable resins and the like are usable as the second resin because these resins allow the optical adjustment layer 103 to be formed by an easier step. Such resins specifically include acrylate resins, methacrylate resins, epoxy resins, oxetane resins, silicone resins, ene-thiol resins, and the like. As described above, as the third resin contained in the adhesive material, a resin copolymerizable with the second resin may be selected.

In the case of using resin materials, as compared with the case of using glass, it is difficult to select materials which are significantly different in the refractive index and the wavelength dispersion thereof. Namely, there is a small number of combinations of the first optical material containing the first resin and the second optical material containing the second resin which fulfill expression (1). In order to solve this problem, a composite material having inorganic particles dispersed in the resin used as the matrix material can be used as the second optical material for the optical adjustment layer 103. The refractive index and the Abbe number of the second optical material are adjustable in accordance with the type, amount and size of the inorganic particles to be dispersed in the matrix material. Thus, the number of candidates for the combinations of the first optical material and the second optical material which fulfill expression (1) can be increased. In addition, since the first optical material and the second optical material can fulfill expression (1) with higher precision, the diffraction grating the diffractive optical element 151 can be further improved. In addition, resin materials having various properties can be made usable. As a result, the range of selection of the second optical material which fulfills the optical characteristics as well as the mechanical characteristics, environment resistance and ease of handling in the production process is broadened.

In the case where the first optical material containing the first resin is used for the body 102 and a composite material is used as the second optical material for the optical adjustment layer 103, the following is made possible. The inorganic particles generally have a refractive index higher than that of the resin. Therefore, the composite material may be adjusted so as to have a high refractive index and a low wavelength dispersion, so that the ranges of materials selectable as the inorganic particles, the first resin and the second resin are broadened.

The refractive index of the second optical material, which is a composite material, can be estimated from the refractive indexes of the second resin used as the matrix material and the inorganic particles based on, for example, the Maxwell-Garnet theory represented by the following expression (2). By estimating the refractive indexes for the d line (587.6 nm), the F line (486.1 nm) and the C line (656.3 nm) from expression (2), the Abbe number of the composite material can be estimated. Oppositely, the mixture ratio of the second resin used as the matrix material and the inorganic particles may be determined by the estimation made based on this theory.

$${n}_{COM λ}^{2} = \frac{{n}_{p λ}^{2} + 2 {n}_{m λ}^{22} + 2 P ( {n}_{p λ}^{2} + 2 {n}_{m λ}^{2} )}{{n}_{p λ}^{2} + 2 {n}_{m λ}^{2} - P ( {n}_{p λ}^{2} + 2 {n}_{m λ}^{2} )} {n}_{m λ}^{2} \qquad ( 2 )$$

In expression (2), n_{COMλ} is the average refractive index of the composite material for light of a particular wavelength λ, and n_{pλ} and n_{mλ} are refractive indexes of the inorganic particles and the second resin used as the matrix material for light of the wavelength λ, respectively. P is the volume ratio of the inorganic particles with respect to the entire composite material. In the case where the inorganic particles absorb light or contain metal, the refractive indexes in expression (2) are considered as complex refractive indexes for calculation.

As described above, in the case where a composite material is used as the second optical material for the optical adjustment layer 103, it is preferable that the composite material has a high refractive index and a low wavelength dispersion. Therefore, it is preferable that the inorganic particles to be dispersed in the composite material contain a material having a low wavelength dispersion, namely, a high Abbe number, as a main component. For example, at least one oxide selected from the group consisting of zirconium oxide (Abbe number: 35), yttrium oxide (Abbe number: 34), lanthanum oxide (Abbe number: 35), alumina (Abbe number: 76), silica (Abbe number: 68), hafnium oxide (Abbe number: 32), YAG (Abbe number: 52) and scandium oxide (Abbe number: 27) may be used as the main component. A composite oxide of any of these materials is usable. In addition, the inorganic particles described above may coexist with inorganic particles or the like exhibiting a high refractive index, such as, for example, titanium oxide, zinc oxide or the like, as long as the refractive index of the second optical material, which is the composite material, fulfills expression (1) for the wavelength range of the light to be used.

It is preferable that the inorganic particles in the composite material have a median particle c diameter of 1 nm or greater and 100 nm or less. When the central particle diameter is 100 nm or less, the loss due to the Rayleigh scattering can be decreased and thus the transparency of the optical adjustment layer 103 can be improved. When the median particle diameter is 1 nm or greater, the influence of light emission or the like due to the quantum effect can be suppressed. Into the composite material, an additive such as a dispersant for improving the dispersion characteristic of the inorganic particles, a polymerization initiator, a leveling agent or the like may be incorporated when necessary.

In the case where the optical adjustment layer 103 is formed using a composite material as the second optical material, a solvent is allowed to coexist during the formation step thereof. The solvent contained in the composite material is used to make it easy to disperse the inorganic particles in the second resin, or to adjust the viscosity so that the optical adjustment layer 103 is formed with no air bubbles. Regarding the type of solvent, a solvent which fulfills required characteristics, for example, dispersibility of the inorganic particles, solubility of the resin to be used as the matrix material of the composite material, ease of handling in the production process (wettability with the body, ease of drying (boiling point, vapor pressure), etc.) or the like may be selected.

3. Adhesion Interface Section 109

The adhesive interface section 109 has a strong interaction with each of the body 102 and the optical adjustment layer 103 in the second area 106, which is other than the first area 105 having the diffraction grating 104, and thus suppresses the delamination of the optical adjustment layer 103 from the body 102. The adhesive interface section 109 is located at the second area 106 of the surface 102a of the body 102. At least a part of the adhesive interface section 109 is located below the optical adjustment layer 103, and the adhesive interface section 109 is located in a region from the surface 102a to the inside of the body 102. The adhesive interface section 109 is not provided in the first area 105 having the diffraction grating 104. In the first area 105, the optical adjustment layer 103 and the surface 102a of the body 102 are in direct contact with, and adhere to, each other. In this embodiment, as shown in FIG. 1(a), the adhesive interface section 109 located at the second area 106 of the surface 102a of the body 102 continuously surrounds the first area 105 and is ring-shaped. The entirety of the adhesive interface section 109 is located below the optical adjustment layer 103. In the case where the diffraction grating 104 including the plurality of rings located concentrically is provided at the first area 105 of the surface 102a of the body 102, it is preferable that the center of the ring-shaped adhesive interface section 109 matches the center of the concentric rings as shown in FIG. 1(a). In this case, a force acting between the body 102 and the optical adjustment layer 103 via the adhesive interface section 109 is uniformly dispersed with respect to the center of the concentric rings of the diffraction grating 104 (with respect to an optical axis 111 of the diffractive optical element 151). Therefore, the stress generated when the optical adjustment layer 103 is formed is made uniform. As a result, the delamination of the optical adjustment layer 103 from the body 102, which would start from a specific position at which the stress is concentrated, can be suppressed.

There is no specific limitation on the width of the adhesive interface section 109 at the surface 102a in the radial direction of the concentric rings of the diffraction grating 104, as long as a certain level of adhesiveness is provided between the body 102 and the optical adjustment layer 103 by the adhesive interface section 109. For example, in the case where the diameter of the first area 105 is 0.5 mm or greater and 5.0 mm or less, the width of the adhesive interface section 109 at the surface 102a is preferably 10 μm or greater, and is more preferably 50 μm or greater. The upper limit of the width is defined by the design of the entire diffractive optical element 151; more specifically, by the width of the second area 106 of the surface 102a of the body 102.

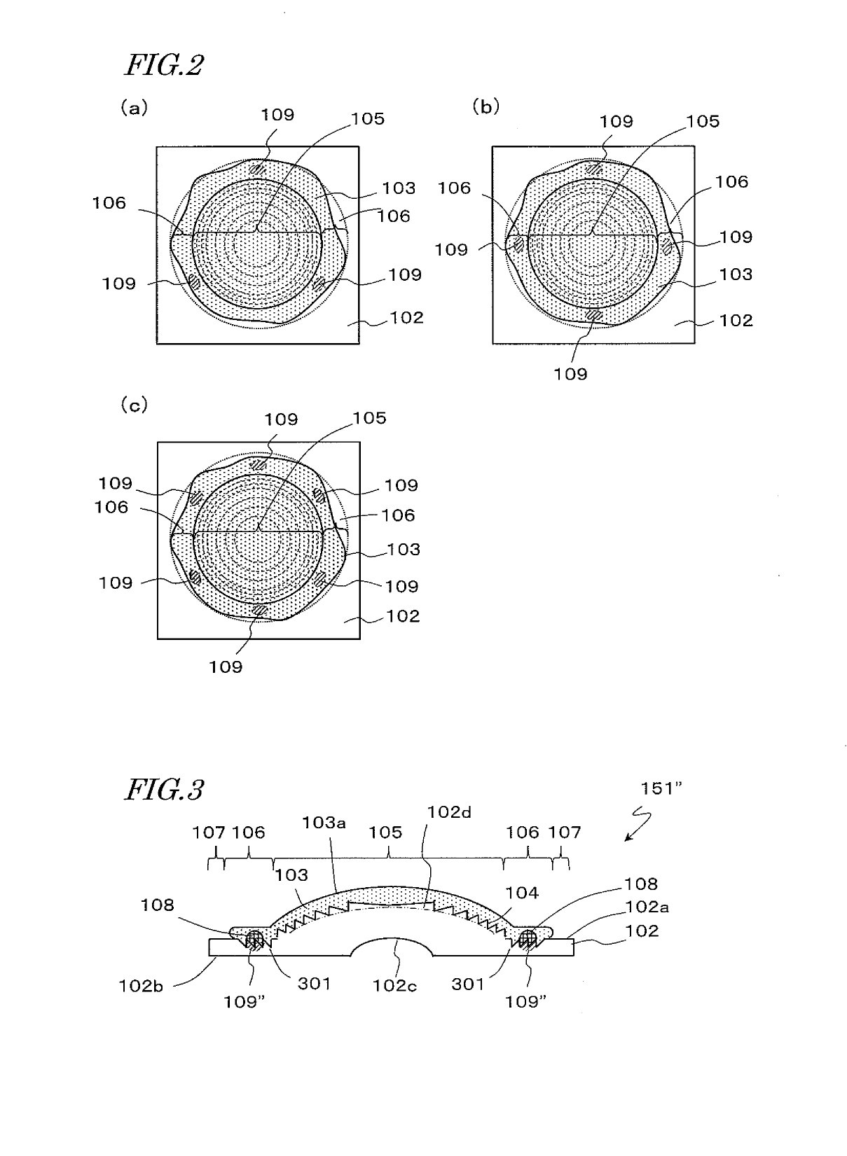

The diffractive optical element 151 may include a plurality of independent adhesive interface sections 109. As shown in FIGS. 2(a), 2(b) and 2(c), the plurality of adhesive interface sections 109 may be provided at the second area 106 of the surface 102a of the body 102 at an interval around the first area 105. In this case, it is preferable that the plurality of adhesive interface sections 109 are located on a circle having a center matching the center of the concentric rings of the diffraction grating 104, namely, on a circle concentric with the concentric rings. Where the number of the adhesive interface sections 109 is N, it is preferable that the adhesive interface sections 109 are located at an interval of 360/N (degrees). FIGS. 2(a), 2(b) and 2(c) show cases where N is 2, 3 and 6, respectively, but there is no specific limitation on the number of the adhesive interface sections 109. By locating the adhesive interface sections 109 at an interval of 360/N (degrees), the stress generated in the optical adjustment layer 103 is made uniform with respect to the center of the concentric rings of the diffraction grating 104 (with respect to the optical axis 111 of the diffractive optical element 151) as described above.

The adhesive interface section 109 contains an adhesive material which is adhesive to the second optical material used to form the optical adjustment layer 103. In this embodiment, the adhesive material contains the third resin, which is different from the first resin contained in the first optical material used to form the body 102 and also different from the second resin contained in the second optical material used to form the optical adjustment layer 103. A substance of the third resin is soluble and permeable into the first optical material used to form the body 102 and interacts with the second optical material used to form the optical adjustment layer 103.

The adhesive interface section(s) 109 is(are) formed as follows. On the second area 106 of the surface 102a of the body 102, an adhesive material piece(s) is(are) located with the shape and by number of the adhesive interface section(s) 109 described above, so that the third resin permeates into the inside of the body 102 from the surface 102a.

Since the substance of the third resin permeates into the inside of the body 102 from the surface 102a, the substance of the third resin is dispersed into the inside of the body 102 from the surface 102a. As a result, an area having a composition different from that of the first optical material is formed in the body 102. This area having composition different from that of the first optical material is defined as the adhesive interface section 109. The adhesive interface section 109 contains the first optical material and the third resin. It can be confirmed that the adhesive interface section 109 is present in the body 102 by specifying the composition of the materials by use of a method such as FT-IR, Raman spectroscopy, NMR, X-ray microanalysis or the like, or by detecting a change of the composition. In the case where the refractive index changes in accordance with the composition by the permeation or dissolution of the adhesive material, the presence of the adhesive interface section 109 can also be confirmed by observation with an optical microscope.

When the substance of the third resin permeates into the inside of the body 102 from the surface 102a, the first optical material in the body 102 may permeate and be dispersed into the adhesive material. In the case where the permeation rate of the first optical material into the adhesive material is high, the interface between the adhesive material and the body 102 is caused not to be clearly observable as a result of the dispersion of the first optical material into the adhesive material located at the surface 102a of the body 102. In this case, as shown in FIG. 1(b), the adhesive material at the surface 102a and the adhesive interface section 109 in the body 102 form together an integral adhesive interface section 109 containing the first optical material and the third resin. Namely, the adhesive interface section 109 is located in a region from the surface 102a of the body 102 to the inside of the body 102, and is also located in a region from the surface 102a of the body 102 to the inside of the optical adjustment layer 103. In this case, the adhesive material is defined as being dissolved in the body 102.

By contrast, in the case where the permeation rate of the first optical material into the adhesive material is low, the first optical material is not contained almost at all in the adhesive material located at the surface 102a of body 102, and thus the interface between the adhesive material and the body 102 is clearly observable. In this case, as shown in FIG. 1(c), on the surface 102a, an adhesive material layer 108 mainly containing only the adhesive material and having a composition different from that of the adhesive interface section 109 is formed. Namely, the adhesive interface section 109 is mainly located in a region from the surface 102a of the body 102 to the inside of the body 102, whereas the adhesive material layer 108 is located in a region from the surface 102a of the body 102 to the inside of the optical adjustment layer 103. In other words, the adhesive material layer 108 is located between the optical adjustment layer 103 and the adhesive interface section 109.

In the adhesive interface section 109, the molecular chains of the first resin contained in the first optical material and the third resin of the adhesive material permeating or dissolved into the body 102 are intertwined with each other at the molecular level. As a result, the adhesiveness between the body 102 and the adhesive interface section 109 is expressed.

The adhesive interface section 109 is formed from the surface 102a of the body 102 to a depth of preferably 0.1 μm or greater and 100 μm or less, more preferably 1 μm or greater and 20 μm or less. When the depth of the adhesive interface section 109 is less than 0.1 μm, the adhesiveness between the body 102 and the adhesive interface section 109 may possibly be insufficient. By contrast, when the depth of the adhesive interface section 109 is larger than 100 μm, this indicates that permeability or solubility of the adhesive material into the body 102 is very high, and the optical characteristics and the shape of the body 102 may have possibly been changed.

The height of the adhesive material layer 108 from the surface 102a shown in FIG. 1(c) or the height of the adhesive interface section 109 from the surface 102a shown in FIG. 1(b) merely needs to be smaller than the thickness of the optical adjustment layer 103. Specifically, the height is preferably 0.1 μm or greater and 95% or less of the thickness of the optical adjustment layer 103, and is more preferably 1 μm or greater and 90% or less of the thickness of the optical adjustment layer 103. When the height is smaller than 0.1 μm, the adhesive interface section 109 formed in the body 102 is also likely to be shallow, and thus the adhesive interface section 109 having a preferable depth described above may possibly not be formed. When the height is larger than 95% of the thickness of the optical adjustment layer 103, a part of the optical adjustment layer 103 which covers the adhesive material layer 108 or the adhesive interface section 109 is excessively thin and thus may possibly not have a sufficient strength.

As described above, in the case where the adhesive material is dissolved in the body 102 and thus the integral adhesive interface section 109 is formed, the position of the surface 102a of the body 102 in the adhesive interface section 109 is not clearly seen. In this case, the depth and the height of the adhesive interface section 109 described above are defined based on the position of the surface 102a in the vicinity of the adhesive interface section 109, namely, in the second area 106 and/or the third area 107.

The adhesive interface section 109 and the optical adjustment layer 103 are bonded together mainly with an adhesive material which is adhesive to the second optical material. In the case where the integral adhesive interface section 109 is provided as shown in FIG. 1(c), the adhesive interface section 109 and the optical adjustment layer 103 directly contact each other. Therefore, the adhesive interface section 109 and the optical adjustment layer 103 adhere to each other with an adhesive material. In the case where the adhesive material layer 108 is provided, the adhesive material layer 108 formed of an adhesive material contacts the optical adjustment layer 103. Therefore, the adhesive interface section 109 and the optical adjustment layer 103 adhere to each other owing to the adhesive material layer 108 and the adhesive interface section 109.

The adhesiveness of the adhesive material to the second optical material is provided by an interaction between the adhesive material and the second optical material. The interaction is, specifically, covalent bond formation caused by copolymerization of the second resin contained in the second optical material and the third resin contained in the adhesive material, or ionic bond, hydrogen bond, it electron interaction, coordinate covalent bond or the like of the second resin and the third resin.

It is preferable that the third resin contained in the adhesive material has a property of permeating or being dissolved into the first optical material used to form the body 102. Specifically, it is preferable that the difference between the solubility parameter of the third resin and the solubility parameter of the first resin contained in the first optical material is 0.8 [cal/cm³]^{1/2} or less. When the difference is in such a range, the third resin is likely to permeate or be dissolved into the body 102, and thus a high adhesiveness can be provided.

Meanwhile, regarding the interaction between the third resin and the second optical material, an appropriate mechanism is selected from the above-described interactions in accordance with the composition of the second optical material. Especially in the case where an energy-curable resin which can be easily processed is used as the second resin contained in the second optical material, it is preferable that an energy-curable resin which easily forms a covalent bond by copolymerization with the second resin is used as the third resin. When such materials are used, a covalent bond is formed between the second resin and the third resin at the same time as the formation of the optical adjustment layer 103 by a curing reaction of the second resin. As a result, the optical adjustment layer 103 and the adhesive material layer 108 can be strongly bonded to each other.

From the above-described viewpoints, the third resin contained in the adhesive material may be a resin copolymerizable with the second resin described later among resins having vinyl group, acrylic group, methacrylic group, epoxy group and oxetane group; silicone resins; ene-thiol resins; and the like.

The adhesive material may contain a polymerization initiator for curing the third resin, a resin or an elastomer for increasing the adhesiveness, an inorganic filler or a thickener for improving the workability during the production steps, or any other necessary additive, in addition to the third resin.

In the diffractive optical element in this embodiment, the adhesive interface section containing the adhesive material which is adhesive to the second optical material is provided at the second area of the surface of the body in a region from the surface to the inside of the body. Therefore, the adhesive interface section acts an anchor to cause the optical adjustment layer and the body to adhere to each other. This can prevent an end of the optical adjustment layer from floating, or from being delaminated, from the body due to the stress caused by the contraction of the resin or the release of the resin from the die in the step of forming the optical adjustment layer. Thus, faults during the production can be suppressed to improve the yield. In addition, an end of the optical adjustment layer can be prevented from gradually floating, or from being gradually delaminated, from the body due to environmental changes or long-term use. Therefore, the long-term reliability of the diffractive optical element can be improved. Since the adhesive interface section is provided in the second area outer to the area where the diffraction grating is provided, the optical characteristics of the diffraction grating are not spoiled.

In this embodiment, even in the case where the first resin contained in the first optical material is a thermoplastic resin, which can be processed by injection molding or the like providing a high productivity and basically does not contain, in the resin molecular chain, any functional group copolymerizable with any other material, a certain level of adhesiveness can be provided between the body and the optical adjustment layer by a simple and effective manner.

In this embodiment, the second area 106 is flat. Alternatively, the second area 106 may have any other shape. A diffractive optical element 151″ shown in FIG. 3 has grooves and thus has a concaved and convexed-shaped part 301 at the second area 106 of the surface 102a. An adhesive material is provided on the concaved and convexed-shaped part 301 and is caused to permeate into the body 102. Thus, an adhesive interface section 109″ is located in a region from the surface of the concaved and convexed-shaped part 301 to the inside of the body 102. As a result, the contact area size between the body 102 and the adhesive interface section 109″ located in the body 102 is increased and thus an anchor effect is expressed. Therefore, the adhesiveness therebetween is further improved.

In FIG. 3, the concaved and convexed-shaped part 301 has a sawtooth-shaped cross-section. There is no specific limitation on the shape of the cross-section of the concaved and convexed-shaped part 301 as long as a certain level of adhesiveness is provided between the body 102 and the adhesive material layer 108. The concaved and convexed-shaped part 301 may have a rectangular, triangular or arcked cross-section. The concaved and convexed-shaped part 301 at the second area 106 of the surface 102a may be a surface roughened by grain finish, sandblast or the like. These shapes may be combined.

In the above-described case, it is preferable that the depth of the adhesive interface section 109″ is in the above-described range from the lowest level of the concaved and convexed-shaped part 301.

In this embodiment, as shown in FIG. 1, FIG. 2 and FIG. 3, the adhesive material layer 108, and the adhesive interface layer 109, 109′ and 109″ each have a convexed cross-section at an interface with the optical adjustment layer. Alternatively, these layers may each have a cross-section of any other shape, for example, a rectangular, triangular, or wavy cross-section as long as a certain level of adhesiveness is provided between the body 102 and the optical adjustment layer 103.

### Embodiment 2

Hereinafter, a diffractive optical element according to Embodiment 2 of the present invention will be described.

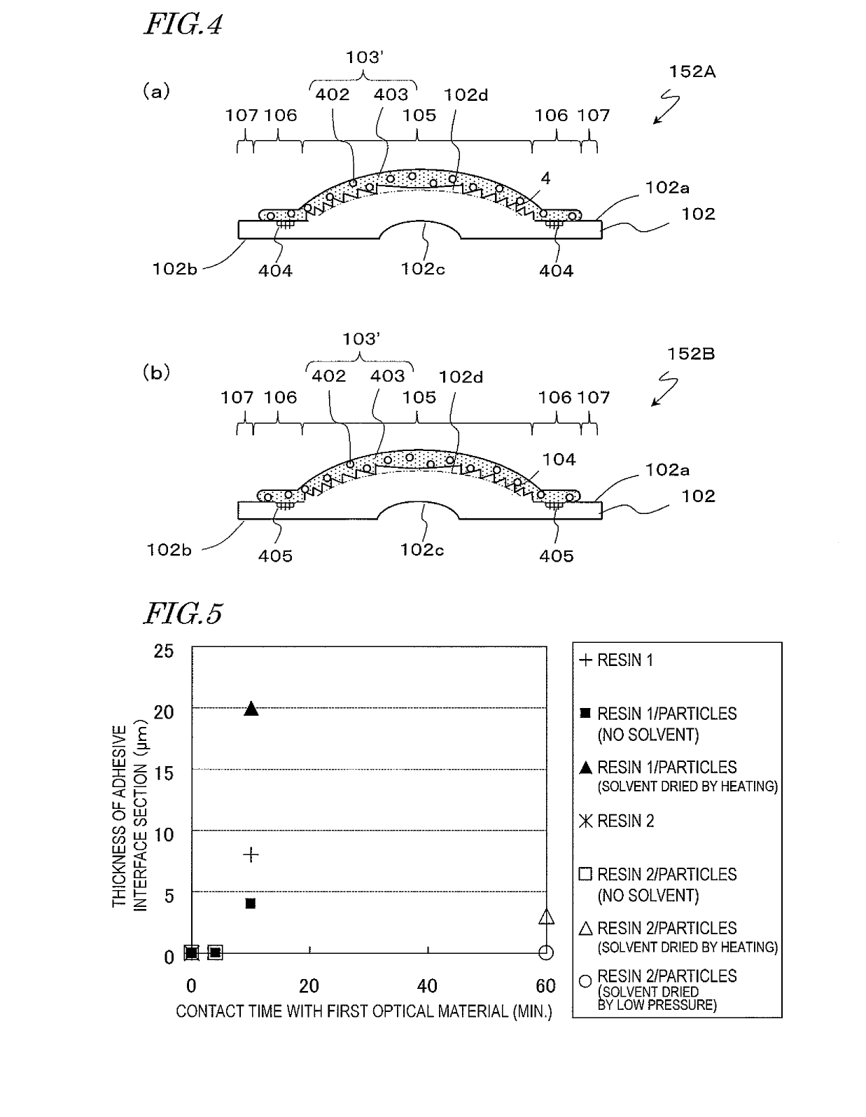

FIG. 4 shows cross-sectional structures of a diffractive optical element 152A in Embodiment 2. As shown in FIG. 4(a), the diffractive optical element 152A includes the body 102, an optical adjustment layer 103′, and an adhesive interface section 404. The adhesive interface section 404 is located at the second area 106 of the surface 102a of the body 102 in a region from the surface 102a to the inside of the body 102. However, unlike in Embodiment 1, the adhesive interface section 404 is not located above the surface 102a, and the adhesive interface section 404 contains the second resin instead of the third resin. Regarding the rest of the structure, the diffractive optical element 152A is the same as that in Embodiment 1.

In FIG. 4, the second optical material used to form the optical adjustment layer 103′ is a nanocomposite material having inorganic particles 402 dispersed in a matrix material 403 containing the second resin. The second optical material is not limited to a nanocomposite material and may be any other material which contains the second resin.

The solubility and the permeability of the adhesive material into the first optical material used to form the body 102 are influenced by the polarity and the molecular size of the chemical substance having the solubility parameter as one index, as well as, for example, the ambient environments such as the temperature and the like, and coexisting chemical substances such as the solvent, additives and the like. For example, under a high temperature, the mobility of the molecular chain of the first resin contained in the first optical material becomes high. Therefore, the adhesive material easily enters the gaps of the molecular chain of the first resin, and thus the solubility and the permeability are improved. The solvent generally have small-sized molecules and is considered to easily enter the gaps of the molecular chain of the first resin. Namely, the solvent swells the first resin and enlarges the gaps of the molecular chain of the first resin. Therefore, in the case where the adhesive material is dissolved in the solvent, the adhesive material permeates or is dissolved more easily than in the case where the adhesive material is independently in contact with the first resin.

In the case where a polycarbonate resin is used as the first resin in the first optical material, the thickness of the adhesive interface section formed in the polycarbonate resin is as shown in FIG. 5. In FIG. 5, samples of the adhesive material are respectively two types of energy-curable resins and nanocomposite materials containing the respective energy-curable resins. As shown in FIG. 5, even when the same adhesive material is used, the thickness of the adhesive interface section is significantly different by the length of contact time with the first optical material, presence/absence of the solvent, and the method for drying the solvent.

Based on the above, even if the optical adjustment layer 103 formed on the first area 105 of the surface 102a of the body 102 and the adhesive material provided at the second area 106 of the surface 102a of the body 102 are formed of the same material, namely, the second optical material containing the second resin, it is possible that the adhesive interface section is not formed at the first area 105 of the surface 102a of the body 102 and the adhesive interface section 404 is formed only at the second area 106 if the optical adjustment layer 103 and the adhesive material are formed in separate steps.

In the case where an energy-curable resin is used as the second resin contained in the second optical material for the optical adjustment layer 103, an uncured part of the substance is highly permeable and soluble into the first optical material containing the first resin used to form the body 102. Therefore, in the step of forming the optical adjustment layer 103, the contact time of the body 102 with the adhesive material containing the second resin is made sufficiently longer than the contact time of the body 102 with the substance of the optical adjustment layer 103, and/or the adhesive material and the body 102 are put into contact with each other under a high temperature. By such an arrangement, the adhesive interface section 404 can be formed only below the second area 106. Alternatively, the adhesive interface section 404 may be formed by a step of putting only the adhesive material in a state of being dissolved in a solvent into contact with the body 102 and then removing the solvent by heating or vacuum drying.

In the above-described case, the optical adjustment layer 103 and the adhesive material are formed of the same material. Therefore, in the diffractive optical element 401 obtained as a final product, the optical adjustment layer 103 and the adhesive material are integrated together and thus the presence of the adhesive material is not confirmed as shown in FIG. 4. By contrast, in the depth direction from the second area 106 of the surface 102a of the body 102 in which the adhesive material is provided, the adhesive material containing the second resin permeates or is dissolved, and thus the adhesive interface section 404 is formed. The presence of the adhesive interface section 404 can be confirmed by the method described in Embodiment 1.

In the case where a nanocomposite material containing the second resin in the matrix material 403 is used for the optical adjustment layer 103 and for the adhesive material and thus the adhesive interface section 404 is formed by the permeation of the adhesive material, the adhesive interface section 404 has an organic component, containing the second resin, permeating thereinto and does not contain the inorganic particles 402 contained in the nanocomposite material. A reason for this is that the inorganic particles 402 having a size of the nanometer order is too large for the gaps of the molecular chain of the first optical material used to form the body 102 and cannot permeate into the body 102. By contrast, as shown in FIG. 4(b), in the case where the adhesive material is dissolved in the first optical resin used to form the body 102, a diffractive optical element 152B including an adhesive interface section 405 which further contains the inorganic particles 402 at a ratio in accordance with the solubility of the adhesive material into the first optical material is formed.

As described above, in the case where a nanocomposite material is used as second optical material and as the adhesive material, a solvent may be allowed to coexist during the production process. Especially in the case where a nanocomposite material is used as the adhesive material, the solvent has a function of adjusting the dispersibility of the inorganic particles and the viscosity as well as a function of promoting the permeation or dissolution of the adhesive material into the first optical material and thus assisting the formation of the adhesive interface section 404 or 405.

In the diffractive optical element in this embodiment, the adhesive material contains the second resin. Therefore, the covalent bond of the optical adjustment layer 103 and the layer of the adhesive material is formed easily, and thus a certain level of adhesiveness is provided between these layers. As facilities for arranging the position of the layer of the adhesive material, facilities for arranging the position of the substance of the optical adjustment layer 103 are usable, which can further increase the productivity. As a result, diffractive optical elements realizing both of high optical characteristics and high yield and reliability can be produced at high productivity.

### Embodiment 3

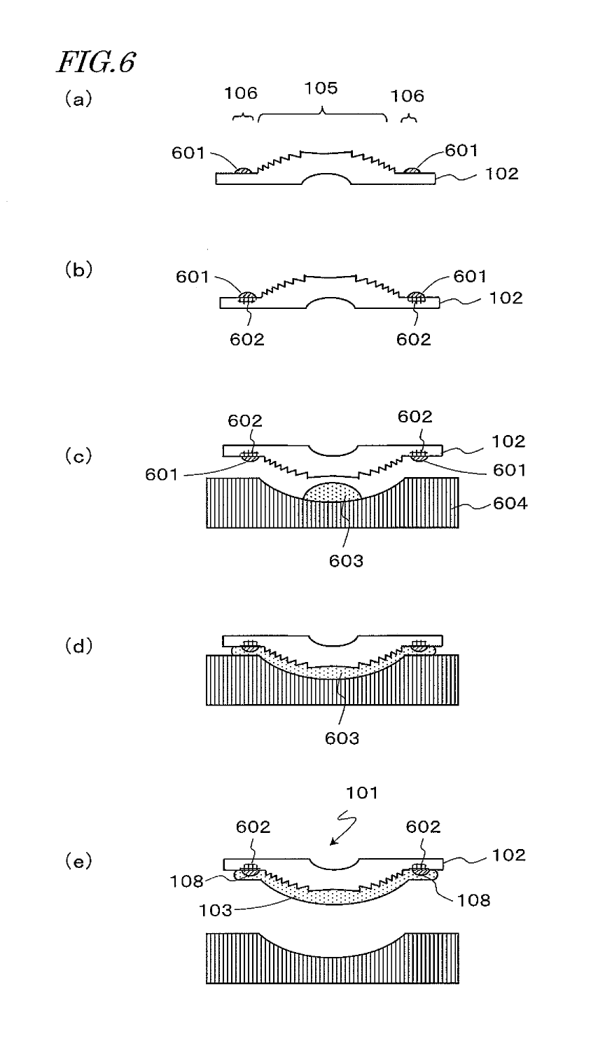

A method for producing a diffractive optical element according to an embodiment of the present invention will be described. First, as shown in FIG. 6(a), the body 102 having the diffraction grating 104 formed at the first area 105 of the surface 102a is prepared. The body 102 having the diffraction grating 104 formed at the first area 105 of the surface 102a is formed by use of the first optical material containing the first resin. As described above, the surface of the body 102 may be spherical or aspherical and have a lens function, or may be flat. The diffraction grating 104 of the first area 105 and the concaved and convexed-shaped part 301 (not shown in FIG. 6) to be formed at the second area 106 can be formed by a method suitable to the shape thereof and the material of the body 102, for example, molding, transference, cutting, grinding, polishing, laser processing, etching or the like. Since the body 102 is to be formed of the first optical material containing the first resin, it is very easy and preferable to integrally form the body 102 having the diffraction grating 104 and the concaved and convexed-shaped part 301 by molding such as injection molding or the like. Such an arrangement can significantly improve the productivity. According to an alternative method, the body 102 having the diffraction grating 104 is integrally formed by molding, and only the concaved and convexed-shaped part 301 at the second area 106 may be formed by cutting by use of a cutting tool or the like. Since the first body 102 is formed of the first optical material containing the first resin, the concaved and convexed-shaped part 301 can be formed easily by such a method.

In the case where the body 102 is integrally formed by molding, it is preferable that the depth of the diffraction grating 104 is 20 μm or less in order to allow the die to be produced easily and to form the diffraction grating 104 with high processing precision. When the depth of the diffraction grating 104 exceeds several tens of micrometers, it is difficult to produce the die with high precision, for the following reason. In general, a die is shaped by cutting by use of a cutting tool. When the diffraction grating 104 is deep, the amount of processing work is increased and thus the tip of the cutting tool is abraded. Therefore, as the processing work proceeds, the processing precision is decreased. In addition, when the diffraction grating 104 is deep, it is difficult to make the pitch small, for the following reason. When the diffraction grating 104 is deep, a cutting tool having a tip of a large radius of curvature needs to be used. As a result, the pitch of the diffraction grating 104 needs to be large to a certain degree. For these reasons, as the diffraction grating 104 is deeper, the freedom of design is decreased, and thus the effect of decreasing the aberration, which would be provided by introduction of the diffraction grating 104, is not expressed.

Next, a substance 601 of the adhesive material containing the second resin or the third resin is provided on the second area 106 of the surface 102a of the body 102 (FIG. 6(a)).

The method for providing the substance 601 of the adhesive material on the body 102 is appropriately selected from known coating layer formation methods in accordance with, for example, the characteristics of the material such as the viscosity or the like and the size of the layer of the adhesive material. Specific usable methods include application by use of a liquid injection nozzle such as a dispenser or the like, application by jetting such as an inkjet method and the like, application by squeezing such as screen printing, pad printing and the like, transference, and the like. These methods may be combined appropriately.

Before a curing step described later, the substance 601 of the adhesive material containing the second resin or the third resin permeates or is dissolved into the body 102, and as a result, an adhesive interface section 602 is formed in the depth direction from the second area 106 of the surface 102a of the body 102 (FIG. 6(b)). In the case where the substance 601 of the adhesive material contains a solvent, the solvent is removed by heating or vacuuming if necessary. Especially when a heating treatment is performed to remove the solvent, the permeation or the dissolution of the adhesive material into the body 102 proceeds at the same time as the removal of the solvent, and thus the formation of the adhesive interface section 602 is promoted. Even in the case where the substance 601 of the adhesive material does not contain a solvent, a heating treatment similarly promotes the formation of the adhesive interface section 602.

Next, a substance 603 of the second optical material containing the substance of the second resin is prepared and is provided on the body 102 so as to completely cover the diffraction grating 104 and also cover at least a part of the substance 601 of the adhesive material provided in the previous step.

The method for providing the substance 603 of the second optical material on the body 102 is appropriately selected from known coating layer formation methods in accordance with the characteristics of the material such as the viscosity or the like and the shape precision of the optical adjustment layer 103 which is determined based on the optical characteristics required of the diffractive optical element 151. Specific usable methods include, for example, various types of molding methods using a die, and application by rotation such as spin coating and the like, as well as the methods described above regarding the step of providing the component 601 of the adhesive material. These methods may be combined appropriately. Among the above-described methods, any of molding, pad printing and screen printing, or a combination thereof is especially preferable from the viewpoint of smoothing the surface of the optical adjustment layer 103 after burying the diffraction grating 104.

For providing the substance 603 of the second optical material by molding, the substance 603 of the second optical material is first provided on a die 604 (FIG. 6(c)). Then, the body 102 having the substance 601 of the adhesive material located thereon is located on the die 604 (FIG. 6(d)). Owing to this, the difference in the contact time with the body 102 between the substance 603 of the second optical material and the substance 601 of the adhesive material is further increased. Especially in the case where the substance 601 of the adhesive material contains the second resin like the second optical material, or in the case where the substance 603 of the second optical material contains a material highly permeable or highly soluble into the first optical material (monomer, oligomer, solvent, etc.), this step allows the adhesive interface section 602 to be formed only in the vicinity of the second area 106 of the surface 102a of the body 102. As a result, the diffractive optical element 151 realizing both of high optical characteristics and high yield and reliability can be provided.

After this step, in the case where an energy-curable resin is used as the second resin and/or the third resin, the component 603 of the second optical material and/or the component 601 of the adhesive material which contain the energy-curable resin are cured. Curing the substance of the second resin cures the entirety of the substance 603 of the second optical material, and thus the optical adjustment layer 103 is formed. Along therewith, a covalent bond of the second resin contained in the second optical material and the second resin or the third resin contained in the adhesive material is formed. Thus, a certain level of adhesiveness is provided between the second optical material and the adhesive material. As a result, the diffractive optical element 151 including the body 102 having the diffraction grating 104 and the optical adjustment layer 103 provided on the surface of the body 102 is completed (FIG. 6(e)).

The curing method may be thermal curing, energy beam radiation or the like in accordance with the type of the resin used. Energy beams usable for the curing step include, for example, ultraviolet beam, visible light beam, infrared beam, electron beam and the like. In the case where the ultraviolet beam is used for curing, a photopolymerization initiator may be incorporated in advance into the substance 603 of the second optical material and/or the substance 601 of the adhesive material. In the case where the electron beam is used for curing, the polymerization initiator is not generally needed.

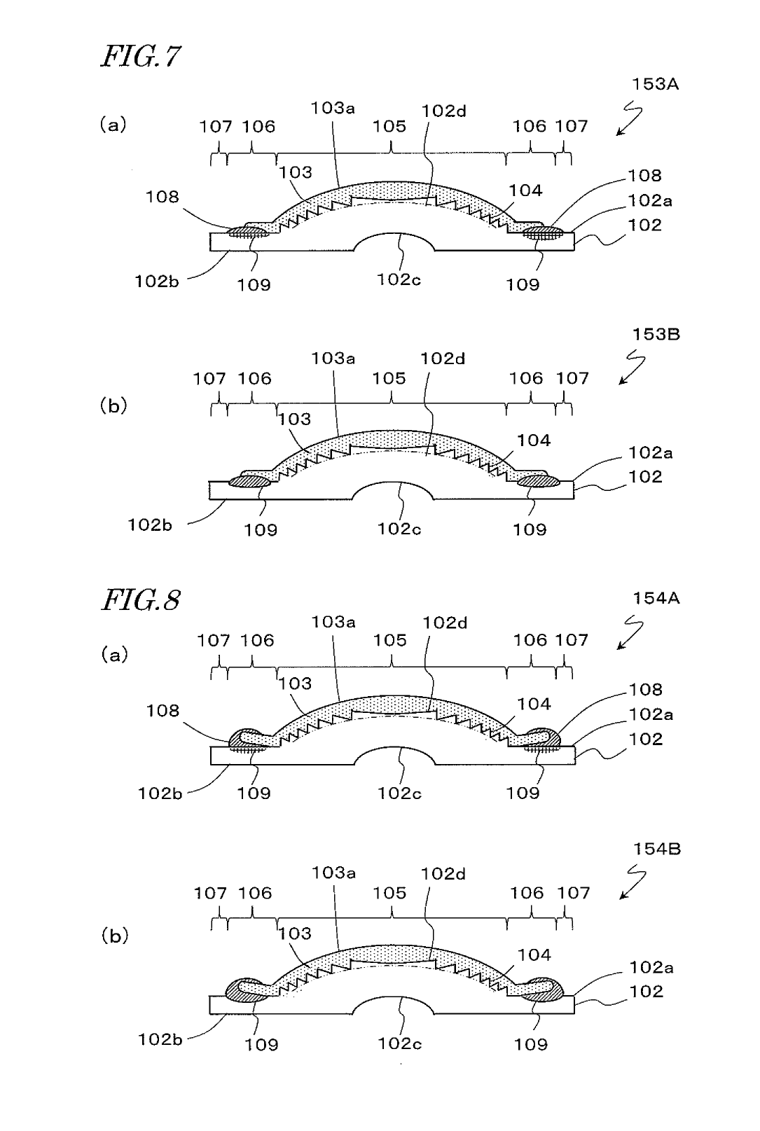

In Embodiments 1 through 3, the adhesive interface section is completely covered with the optical adjustment layer. However, it is sufficient that at least a part of the adhesive interface section is located below, and covered with the optical adjustment layer. For example, as in a diffractive optical element 153A shown in FIG. 7(a), the adhesive interface section 109 and the adhesive material layer 108 may protrude from an end of the optical adjustment layer 103 so that the adhesive material layer 108 is partially exposed. Alternatively, as in a diffractive optical element 153B shown in FIG. 7(b), the adhesive interface section 109 may protrude from an end of the optical adjustment layer 103 so as to be partially exposed.

In the diffractive optical elements 153A and 153B, even in the case where the second area is narrow, the contact area size between the adhesive interface section 109 and the body 102 can be made large. Therefore, in the case where, for example, the substance of the second resin or the third resin of the adhesive interface section 109 does not sufficiently permeate into the body 102, namely, in the case where the adhesive interface section 109 is shallow, the bonding force between the adhesive interface section 109 and the body 102 can be made strong.

It is not necessary that the optical adjustment layer 103 adheres to the surface 102a of the body in the entire second area 106. As in a diffractive optical element 154A shown in FIG. 8(a), an end of the optical adjustment layer 103 may be separated from the surface of the body 102 and the adhesive material layer 108 may cover the separated part of the optical adjustment layer 103. Alternatively, as in a diffractive optical element 154B shown in FIG. 7(b), an end of the optical adjustment layer 103 may be separated from the surface of the body 102 and the adhesive interface section 109 may cover the separated part of the optical adjustment layer 103. In the case where the second optical material contracts significantly during the formation of the optical adjustment layer 103, an end of the optical adjustment layer 103 may possibly float from the body 102. Even in this case, as long as the adhesive material layer 108 or the adhesive interface section 109 covers the end of the optical adjustment layer 103, the end of the optical adjustment layer 103 is prevented from further floating or from being further delaminated from the body 102. Thus, substantially the same effects as those in Embodiments 1 through 3 can be provided.

### EXAMPLES

In order to confirm the effects of the diffractive optical elements in the embodiments, diffractive optical elements were produced and characteristics thereof were evaluated. Hereinafter, the results will be described.

### Example 1

A diffractive optical element in Embodiment 1 was produced as follows. As shown in FIG. 1, as the body 102, an aspherical lens formed of bisphenol A-based polycarbonate resin (diameter: 9 mm; thickness: 0.8 mm; d line refractive index: 1.585; Abbe number: 28; SP value: 9.8) having, on a surface thereof, the diffraction grating 104 including rings having a depth of 15 μm was produced by injection molding. The effective radius of the lens part was 0.821 mm, and the number of rings was 33. The minimum ring pitch was 13 μm, and the near axis R of the diffraction plane (radius of curvature) was −1.0094 mm.

On the second area 106 of the surface 102a of the body 102, a mixture of tricyclodecanedimethyloldiacrylate (SP value: 9.0) and Irgacure (registered trademark) 184 as a photopolymerization initiator (3% by weight with respect to the resin) was provided as a substance of the adhesive material layer 108 so as to surround the ring-like diffraction grating 104 by use of a dispenser.

Next, as the substance of the second optical material, an isopropyl alcohol dispersant (total solid content: 62% by weight) of a mixture of a hydroxyl group-containing acrylic-based oligomer (d line refractive index: 1.539; Abbe number: 46; post-curing density: 1.18 g/cm³; SP value: 11.6), Irgacure 184 as a photopolymerization initiator (3% by weight with respect to the resin) and a zirconium oxide filler (first-order particle diameter: 6 nm; containing 45 parts by weight of silane-based surfactant with respect to 100 parts by weight of zirconium oxide; weight ratio in a solid content: 62% by weight) was produced. 0.4 μL of this substance was provided on a die which defines the aspherical shape by use of a dispenser, and isopropyl alcohol was removed by heating by use of a hot plate (110° C., 8 min.).

On the die on which the substance of the second optical material was provided, the body 102 having tricyclodecanedimethyloldiacrylate provided in the second area 106 was located. The assembly of the die and the body 102 was pressed to form the substance of the second optical material into an aspherical shape by molding. Then, UV radiation (UV irradiance: 170 mW/cm²; UV dose: 5000 mJ/cm²) was performed to form the optical adjustment layer 103 and the adhesive material layer 108 by curing at the same time. The cured layers were released from the die, and thus the diffractive optical element 151 having the structure shown in FIG. 1 was obtained. A cross-section of the obtained diffractive optical element 151 was observed by an optical microscope. It was confirmed that the adhesive material layer 108 was formed with a width of 300 μm and a maximum thickness of 5 μm at the interface between the second area 106 of the surface 102a of the body 102 and the optical adjustment layer 103 and that the adhesive interface section 109 into which tricyclodecanedimethyloldiacrylate appeared to permeate was formed over a depth of 5 μm in a contact area of the body 102 and the adhesive material layer 108.

In the diffractive optical element in Example 1, a certain level of adhesiveness was provided between the optical adjustment layer 103 and the body 102 to the ends of the optical adjustment layer 103. An image shot by the diffractive optical element 151 was good with no conspicuous flair which would have been caused by unnecessary diffracted light or stray light.

### Example 2

A diffractive optical element in Example 2 was produced by substantially the same method as that in Example 1. Unlike in Example 1, the same dispersant as that used for the substance of the second optical material was used for the adhesive material, and removal of isopropyl alcohol by heating by use of a hot plate (110° C., 8 min.) was performed after the step of providing the adhesive material by use of a dispenser. Although the adhesive material layer 108 was not observed by an optical microscope, it was confirmed that the adhesive interface section 404 was formed with a maximum thickness of 20 μm in the depth direction from the second area 106 of the surface 102a of the body 102.

In the diffractive optical element in Example 2, a certain level of adhesiveness was provided between the optical adjustment layer 103 and the body 102 to the ends of the optical adjustment layer 103. An image shot by the diffractive optical element 151 was good with no conspicuous flair which would have been caused by unnecessary diffracted light or stray light.

### Example 3

A diffractive optical element in Example 3 was produced by substantially the same method as that in Example 2. Unlike in Example 2, the adhesive material was provided in a spot-like manner at three positions at degrees of 0°, 120° and 240° on a circumference surrounding the ring-like diffraction grating, instead of being provided so as to surround the ring-like diffraction grating. Although the adhesive material layer 108 was not observed by an optical microscope, it was confirmed that the adhesive interface sections 404 were formed with a maximum thickness of 20 μm in the depth direction from the second area 106 of the surface 102a of the body 102.

In the diffractive optical element in Example 3, a certain level of adhesiveness was provided between the optical adjustment layer 103 and the body 102 to the ends of the optical adjustment layer 103. An image shot by the diffractive optical element 151 was good with no conspicuous flair which would have been caused by unnecessary diffracted light or stray light.

### Comparative Example 1

A diffractive optical element in Comparative example 1 was produced by substantially the same method as that in Example 1. Unlike in Example 1, neither the adhesive material layer 108 nor the adhesive interface section 109 was formed.

In the diffractive optical element in Comparative example 1, a part of the optical adjustment layer 103 which was on the second area 106 of the surface 102a of the body 102 was delaminated from the body 102. The diffractive optical element in this state was held in a high temperature environment (85° C., 200 hours). As a result, the delamination of the optical adjustment layer 103 from the body 102 expanded to the first area 105 of the surface 102a (i.e., the effective area of the diffractive optical element).

An image shot by the diffractive optical element in Comparative example 1 was confirmed to have flair. This is caused because the delamination of the optical adjustment layer 103 deformed the aspherical shape defined for the surface, which deteriorated the light collection characteristic.

### INDUSTRIAL APPLICABILITY

A diffractive optical element disclosed in this application is usable as an image pickup lens for a camera module of a cellular phone, a vehicle-mounted camera module or the like, as well as for a spatial low-pass filter, a polarizing hologram or the like.

### REFERENCE SIGNS LIST

151, 152A, 152B, 153A, 153B Diffractive optical element
154A, 154B, 751, 752, 752A, 752B Diffractive optical element
102, 702, 702a, 702b Body
102a, 102b Surface
102c Curved part
102d Base-shaped part
103, 103′, 703, 703a, 703b Optical adjustment layer
103a Surface of the optical adjustment layer
104, 704, 704a, 704b Diffraction grating
105 First area
106 Second area
107 Third area
108 Adhesive material layer
109, 109″, 404, 405 Adhesive interface section
301 Concaved and convexed-shaped part
402, 722 Inorganic particles
403, 721 Matrix material
601 Substance of the adhesive material
603 Substance of the second optical material
604 Die
705, 705a, 705b Refractive index-changed layer
706 Optical axis
707 Incident light
708 Zeroth-order diffracted light
709 First-order diffracted light
710 Second-order diffracted light
711 Designed output light
712 Output light

1. A diffractive optical element, comprising:
a body formed of a first optical material containing a first resin, the body having a surface including a first area in which a diffraction grating is provided and a second area located outer to the first area;
an optical adjustment layer formed of a second optical material containing a second resin, the optical adjustment layer being provided on the body and covering the second area and the first area of the surface; and
an adhesive interface section containing an adhesive material which is adhesive to the second optical material, the adhesive interface section being, at the second area of the surface of the body, at least partially located below the optical adjustment layer and being located in a region from the surface of the body to the inside of the body.

2. The diffractive optical element of claim 1, wherein the adhesive interface section continuously surrounds the first area at the second area of the surface of the body.

3. The diffractive optical element of claim 1, wherein:
a plurality of the adhesive interface sections are provided; and
the plurality of adhesive interface sections are located at the second area of the surface, at an interval around the first area.

4. The diffractive optical element of claim 2, wherein the body has a curved base-shaped part having a lens function in the first area of the surface, and the diffraction grating includes a plurality of rings located concentrically on the base-shaped part.

5. The diffractive optical element of claim 4, wherein the second area surrounds the first area at the surface, and the adhesive interface section is located in a concentric manner with the concentric rings at the second area, as centered around a point matching the center of the concentric rings of the diffraction grating.

6. The diffractive optical element of claim 1, wherein the adhesive material contains the second resin.

7. The diffractive optical element of claim 6, wherein the second resin is an energy-curable resin.

8. The diffractive optical element of claim 1, wherein the adhesive material contains a third resin.

9. The diffractive optical element of claim 8, wherein the third resin is an energy-curable resin.

10. The diffractive optical element of claim 9, wherein the third resin is a radiation curable resin having a functional group copolymerizable with the second resin.

11. The diffractive optical element of claim 8, wherein a solubility parameter of the third resin and a solubility parameter of the first resin has a difference of 0.8 [cal/cm³]^{1/2} or less.

12. The diffractive optical element of claim 1, wherein the first resin is a thermoplastic resin.

13. The diffractive optical element of claim 1, wherein the adhesive interface section includes, in the second area, a part located in a region from the surface of the body to the inside of the optical adjustment layer.

14. The diffractive optical element of claim 1, further comprising an adhesive material layer located between the adhesive interface section and the optical adjustment layer and containing the adhesive material.

15. The diffractive optical element of claim 1, wherein the body has a concaved and convexed-shaped part located at the second area of the surface, and the adhesive interface section is located in a region from a surface of the concaved and convexed-shaped part to the inside of the body.

16. The diffractive optical element of claim 1, wherein the surface of the body includes a third area which is located outer to the second area and is flat.

17. The diffractive optical element of claim 1, wherein the second optical material contains inorganic particles, which are dispersed in the second resin.

18. The diffractive optical element of claim 1, wherein the optical adjustment layer is in direct contact with the surface of the body in the entirety of the first area.

19. A method for producing a diffractive optical element, comprising the steps of:
(A) preparing a body formed of a first optical material containing a first resin, the body having a surface including a first area in which a diffraction grating is provided and a second area located outer to the first area;
(B) providing a substance of an adhesive material which is adhesive on at least a part of the second area of the surface of the body;
(C) providing a substance of a second optical material containing a substance of a second resin on the body so as to cover the entirety of the first area of the surface of the body and at least a part of the substance of the adhesive material provided on the second area; and
(D) curing the substance of the second resin to form an optical adjustment layer formed of the second optical material.

20. The method for producing the diffractive optical element of claim 19, wherein in the step (D), the substance of the adhesive material is cured at the same time as the substance of the second resin.

21. The method for producing the diffractive optical element of claim 20, wherein in the step (D), the substance of the second resin and the substance of the adhesive material are cured by radiation of an energy beam.

22. The method for producing the diffractive optical element of claim 19, wherein the step (C) includes the steps of:
providing the substance of the second optical material on a die; and
providing, on the die, the body having the substance of the adhesive material provided in the second area.

23. The method for producing the diffractive optical element of claim 19, further comprising step (E) of heating the body after step (C).

24. The method for producing the diffractive optical element of claim 23, wherein the substance of the adhesive material contains a solvent, and in the step (E), the solvent is removed from the substance of the adhesive material.

25. The method for producing the diffractive optical element of claim 19, wherein the body has a concaved and convexed-shaped part at the second area of the surface, and in the step (A), the body is formed by molding by which the concaved and convexed-shaped part at the second area is formed by use of a die having a shape corresponding to the concaved and convexed-shaped part at a surface thereof.
